(19) United States
(12) Patent Application Publication
(10) Pub. No.: US 2014/0164261 A1
(43) Pub. Date: Jun. 12, 2014

(54) SYSTEMS AND METHODS FOR INTERACTIVE PATENT PORTFOLIO VALUATION

(71) Applicants: MAULIN SHAH, New York, NY (US); Samir Deepak Naik, San Francisco, CA (US); Anjali Jindal Naik, San Francisco, CA (US); Thomas Tran, San Francisco, CA (US); Jonathan Chao, San Francisco, CA (US)

(72) Inventors: MAULIN SHAH, New York, NY (US); Samir Deepak Naik, San Francisco, CA (US); Anjali Jindal Naik, San Francisco, CA (US); Thomas Tran, San Francisco, CA (US); Jonathan Chao, San Francisco, CA (US)

(21) Appl. No.: 13/707,633

(22) Filed: Dec. 7, 2012

(51) Int. Cl. G06Q 50/18

(52) U.S. Cl. CPC G06Q 50/184
USPC 705/310

(57) ABSTRACT

The present invention provides means for interactively calculating the value of a patent portfolio held by a company. The invention allows users to input estimated future yearly licensing and/or royalty revenues, as well as a discount factor. The user inputs are interactive so that a user can conduct a sensitivity analysis of the value of the patent portfolio in real-time.

### BACKGROUND

1. Field of the Invention

The present invention relates generally to the field of valuing intellectual property assets, and more specifically, to providing an interactive interface to calculate and display patent portfolio valuations using custom sensitivity inputs.

2. Description of Related Art

Traditional methods of valuing intangible intellectual property assets involve manual calculations and analysis. Such methods include discounted cash flow (DCF)/net present value (NPV) calculations, comparable deal analysis, options-pricing models, and damage and royalty modeling. Each of these methods require extensive manual computation and research, and the resulting valuations are typically static. Multiple calculations must be performed in order to obtain a general range of valuations for the same patent portfolio, and thus a sensitivity analysis requires significant manual effort and time.

With the increasing importance companies are placing on intellectual property and the procurement and enforcement of patent rights, the value a company's patent portfolio is an important factor when considering the overall value of a company.

Thus, there currently exists a need for an interactive tool that allows users to calculate patent portfolio valuations with sensitivity analysis and custom inputs based on a user's future revenue, litigation, and licensing predictions for a company.

### SUMMARY

In an embodiment, the present invention relates to a method for valuing a patent portfolio, comprising: receiving a company name, a revenue estimate, and a discount factor at a valuation server from a user interface; determining, by the valuation server, an average remaining term for a patent portfolio associated with the company; calculating, by the valuation server, a base value of the patent portfolio by multiplying the revenue estimate by the average remaining term; subtracting, by the valuation server, the discount factor from the base value to obtain a net present value of the patent portfolio; and displaying the net present value on the user interface.

In yet another embodiment, the present invention relates to a system for interactively valuing a patent portfolio, comprising: an interface; a company name input on the interface; a revenue estimate input on the interface; a discount factor input on the interface; and a valuation server communicatively coupled to the interface, the valuation server configured to calculate a net present value of a patent portfolio associated with a company name using a revenue estimate and a discount factor input via the interface, wherein the interface is configured to display the net present value, and wherein the interface is further configured to display an updated net present value if the interface receives an updated revenue estimate or an updated discount factor.

In yet another embodiment, the present invention relates to a method for displaying a patent portfolio valuation, comprising: receiving, by a valuation server, a company name, a revenue estimate, and a discount factor from an interface; calculating, by the valuation server, a net present value of a patent portfolio associated with the company name using the revenue estimate and the discount factor; calculating, by the valuation server, a second net present value of the patent portfolio using an adjusted revenue estimate or an adjusted discount factor; and displaying, on the interface, the net present value and the second net present value.

### BRIEF DESCRIPTION OF THE DRAWINGS

These and other embodiments of the disclosure will be discussed with reference to the following exemplary and non-limiting illustrations, in which like elements are numbered similarly, and where:

FIG. 1 is a block diagram of a network architecture in an embodiment of the present invention;

FIG. 2 is a flowchart illustrating the steps taken by an embodiment of the present invention;

FIG. 3 is a screen layout of the valuation interface in an embodiment of the present invention; and

FIG. 4 is a screen layout of the results interface in an embodiment of the present invention.

### DETAILED DESCRIPTION

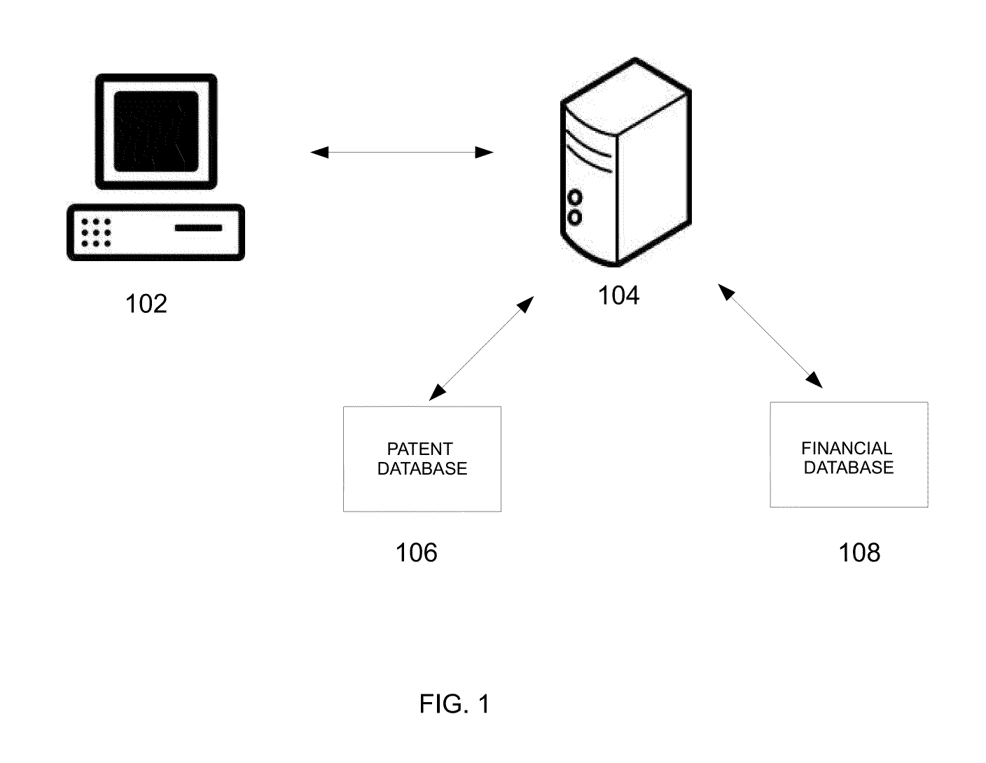

FIG. 1 is a block diagram of a network architecture in an embodiment of the present invention. User device 102 can be any computing device capable of connectivity to a network, such as a desktop computer, laptop computer, netbook, smartphone, tablet computer, or an internet-capable television. User device 102 is coupled, via a communication network, to a valuation server 104. The valuation server 104 is located remotely from the user device 102, such that the user device 102 accesses the valuation server 104 via the communication network. In an alternative embodiment, the valuation server 102 can be downloaded or installed locally on the user device 102.

The valuation server 104 is communicatively coupled to at least one database source, such as a patent database 106 and/or a financial database 108. The patent database 106 can include more than one third-party databases that compile and organize patent data, such as, but not limited to, Thomson Innovation, the USPTO public database, Lexis-Nexis TotalPatent, and the Espacenet at the European Patent Office. In an embodiment, the patent database 106 is a single database that has imported data from at least one third-party patent database.

The financial database 108 can include more than one third-party databases the compile and organize financial data, such as form, but not limited to, Thomson Reuters, Morningstar, Securities and Exchange Commission (SEC) filings databases, and court record databases. In an embodiment, the financial database 108 is a single database that has imported data from at least one third-party patent database. In addition, the financial database 108 can include news sources that report on licensing, joint-venture, and strategic patent initiatives for companies.

In another embodiment, the patent database 106 and the financial database 108 are combined into a single database that is utilized by the valuation server 104.

In an embodiment, the patent database 106 and the financial databases 108 are updated and/or refreshed with data from various third-party databases. The updates can happen on a pre-determined duration, such as in real-time, on an hourly basis, a daily basis, and/or a weekly basis.

Upon receiving a user query through a valuation interface on the user device 102, the query is transmitted to the valuation server 104. The valuation server 104 parses the query, and searches the patent database 106 and the financial database 108. The valuation server 104 retrieves all relevant records from the patent database 106 and the financial database 108, and combines the retrieved records for display on the user device 102, as described in more detail below.

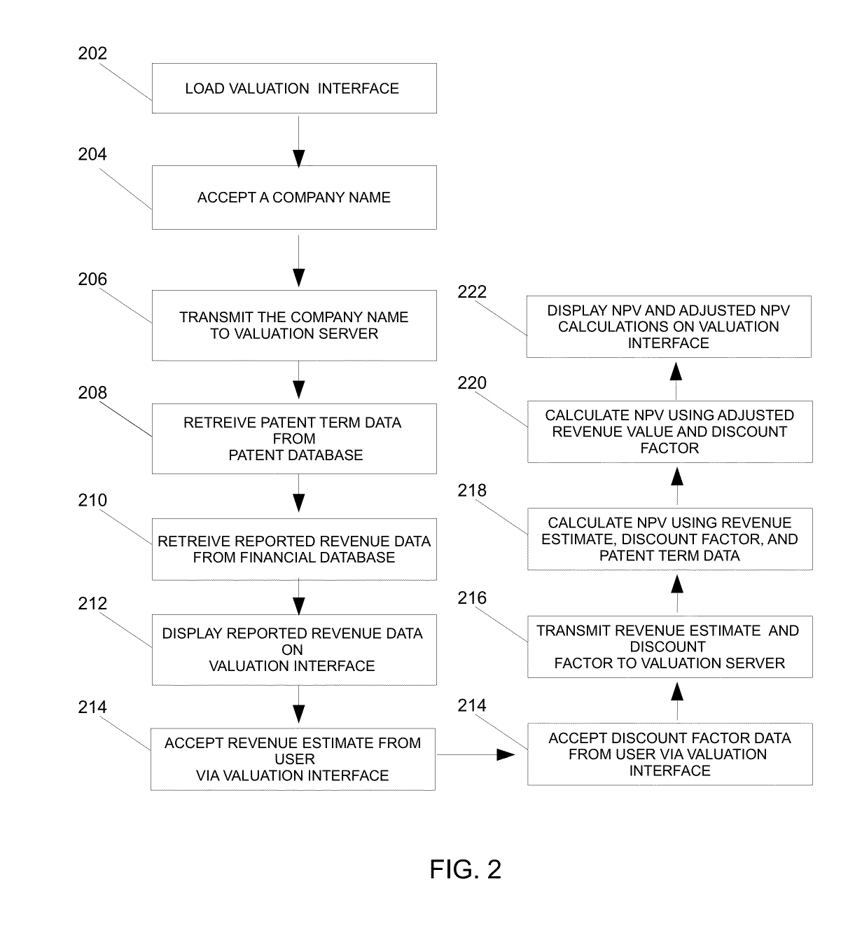

FIG. 2 is a flowchart illustrating the steps taken by an embodiment of the present invention. In step 202, a valuation interface is loaded on the user device 102. The valuation interface can be accessible through a website via an Internet browser, such as Mozilla Firefox or Internet Explorer. A unique URL, such as “http://www.patentwire.com” can be used to access the valuation interface. In an embodiment, prior to accessing the website with the valuation interface, a username and/or password is required, and a subscription may also be required. Upon entering the website, the valuation interface is loaded.

In another embodiment, the valuation interface can be accessed via a desktop application that has been installed or downloaded locally on the user device 102.

Next, in step 204, the user enters a company name or stock symbol, such as XYZ Corporation or XYZ. The valuation interface can provide suggestions as the user is typing, so that, for example, as the user enters the letters X-Y, XYZ Corporation is displayed for selection.

In step 206, the company name is transmitted to the valuation server, which parses the name and transmits the name data to the patent database.

In step 208, patent records having an assignee or re-assignment assignee field matching the company name are retrieved and sent to the valuation server. Each patent record retrieved contains the priority date, filing data, and publication/issue data of the patent. The valuation server calculations the average remaining patent term of the company's patents using the following steps: (1) Removing patent records having a priority date twenty (20) years prior to the current date; (2) Removing patent records that have expired for failure by the patent owner to pay the maintenance fees; (3) Subtracting the current date from the priority date (or filing date if the priority date field is empty) to determine the remaining patent term for each patent record; (4) Summing the calculated patent terms for the entire set of retrieved patent records; and (5) Dividing the sum by the total number of retrieved patent records.

For example, if the user enters XYZ Corp., the valuation server will transmit a query to the patent database requesting the following query: XYZ NEAR5 (Inc. or Incorporated or Corp. or Computer or Corporation or Incorporation) for US patents only. Say, for example, the patent databases retrieves 105 patent records. The valuation server then identifies 5 records that have expired, or which have been abandoned for failure of the patent owner to pay maintenance fees. The resulting set of 100 patent records is used to determine the average remaining patent term. For example, if the sum of the patent terms is 1,000, the valuation server then divides 1,000 by 100 patent records, to obtain an average remaining patent term of 10 years per patent.

In another embodiment, the average remaining term can be calculated at the patent database, or on another database, and stored either on the valuation server for later retrieval, or stored on another database and retrieved by the valuation server upon request.

In step 210, the valuation server transmits the company name to the financial database. The financial database retrieves data related to the company's reported licensing revenue and royalties from SEC filings, trusted news reports and publications, litigation data and court ordered damages and royalty rates available through public court records such as PACER and other publicly available sources. The revenue data is transmitted back to the valuation server. The valuation cleans, formats, and organizes the revenue data.

In step 212, the revenue data is displayed on the valuation interface. The user can view this reported revenue data related directly or indirectly to a company's assets, and can select or enter a revenue value that they believe is indicative of the company's future revenue potential. For example, the financial database returns SEC filing data from 2010 and 2011 showing that a company earned $100M and $150M in licensing revenue, respectively for those years. This revenue data is displayed on the valuation interface, and the user, if they believe that future revenue will be $150M going forward, they can select $150M as the future revenue. The user can also enter their own revenue estimate, for example, if they believe that the licensing revenue will continue to increase, and can enter $200M, for example, as the future revenue estimate.

The displayed revenue data provides the user with guidance on what future revenue values may be, and is provided merely as an informational tool for the user.

In addition, at step 214, the user can select a discount factor. The discount factor is the rate of return that could be earned on an investment in the financial markets with similar risk, or the opportunity cost of capital. In terms of intellectual property assets, a reasonable discount factor range can be from 5% to 25%. The user can enter a discount factor via the valuation interface, using either an input box, a selection box to choose pre-determined discount factor, or a slider scale. The discount factor is not limited to this range, and can be any value between 0% and 100%.

In step 216, the discount factor and the revenue estimate is transmitted to the valuation server from the valuation interface.

In step 218, the valuation server computes a NPV analysis of the company's patent portfolio. NPV can be described as the “difference amount” between the sums of discounted cash inflows and cash outflows. It compares the present value of money today to the present value of money in future, taking inflation and returns into account.

The NPV is calculated by multiplying the revenue estimate by the average remaining patent term to obtain a base value, and then reducing this value by the discount factor to obtain a net present value. For example, using the hypothetical average remaining patent term of 10 years for the XYZ Corp. scenario above, if the user selects $200M in future yearly revenue, and a discount factor of 10%, the NPV would be ($200M×10 years)×(1-0.10)=$1.8 Billion.

In step 220, the valuation server calculates the NPV using a sensitivity analysis by adjusting the discount factor and revenue estimates by pre-set positive and negative values. The adjustment amount can be hard-coded on the valuation server, or it can be set by the user via the interface. For example, the valuation server can calculate the NPV based on a 20% cushion on either side of the revenue estimate, thus calculating the NPV for $240M and $160M in future yearly revenue, in addition to the user's input of $200M. Similarly, the valuation server can calculate the NPV based on a 20% cushion on either side of the discount factor, thus calculating the NPV for discount factors of 12% and 8%, in addition to the user's input of 10%.

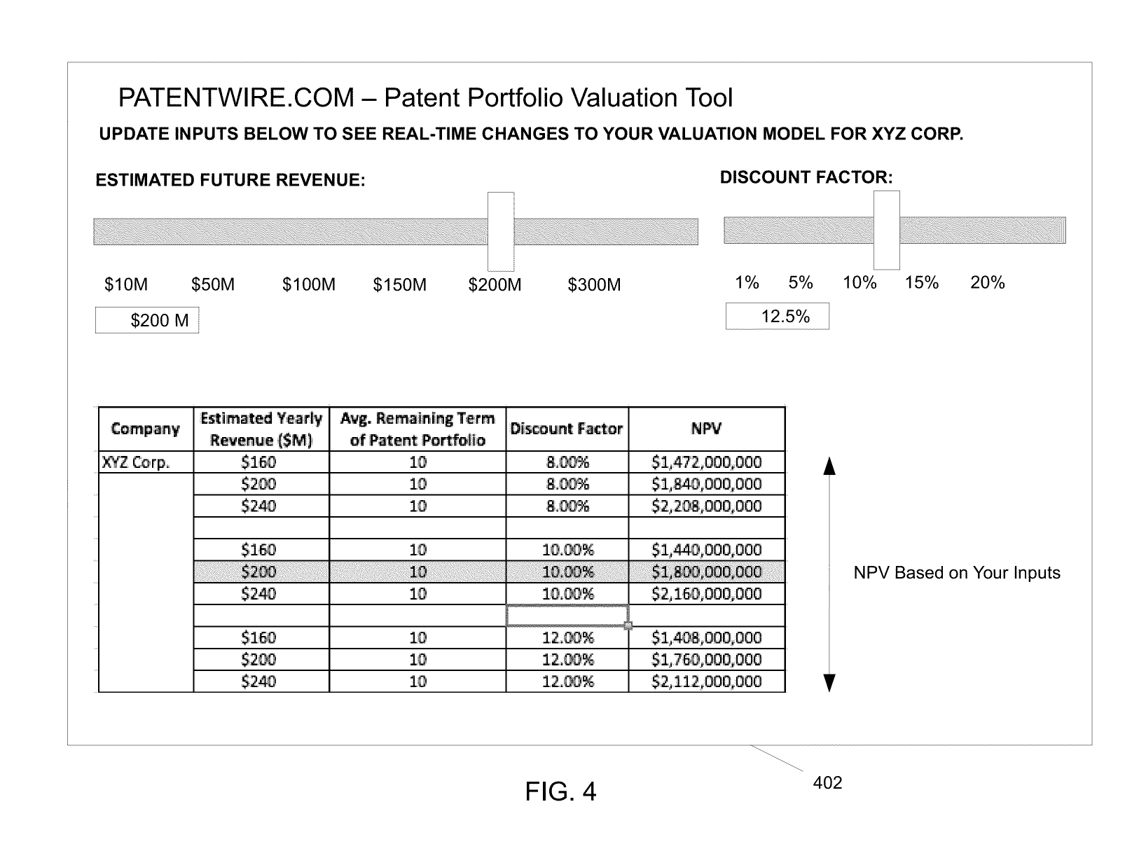

In step 222, all of the calculated NPV values are displayed on the valuation interface. In an embodiment, the NPV values are displayed in a grid format, and the discount factor and revenue estimate values are interactive. Thus, the user can modify the discount factor and revenue estimate values and obtain updated NPV values in real-time. The NPV that is based solely on the user's input can be highlighted to give the user a baseline for their analysis, as shown in FIG. 4.

In an embodiment, the valuation interface can allow users to select a company's entire global patent portfolio, US patent portfolio, European patent portfolio, or any country-specific patent portfolio, and combinations thereof.

In an embodiment, the valuation interface can include at least one or all, and any combination thereof, of any of the aforementioned patent criteria and metrics. In addition, the present invention is not limited to using only the patent criteria described herein, and any patent criteria well known to one skilled in the art can be utilized by the present invention.

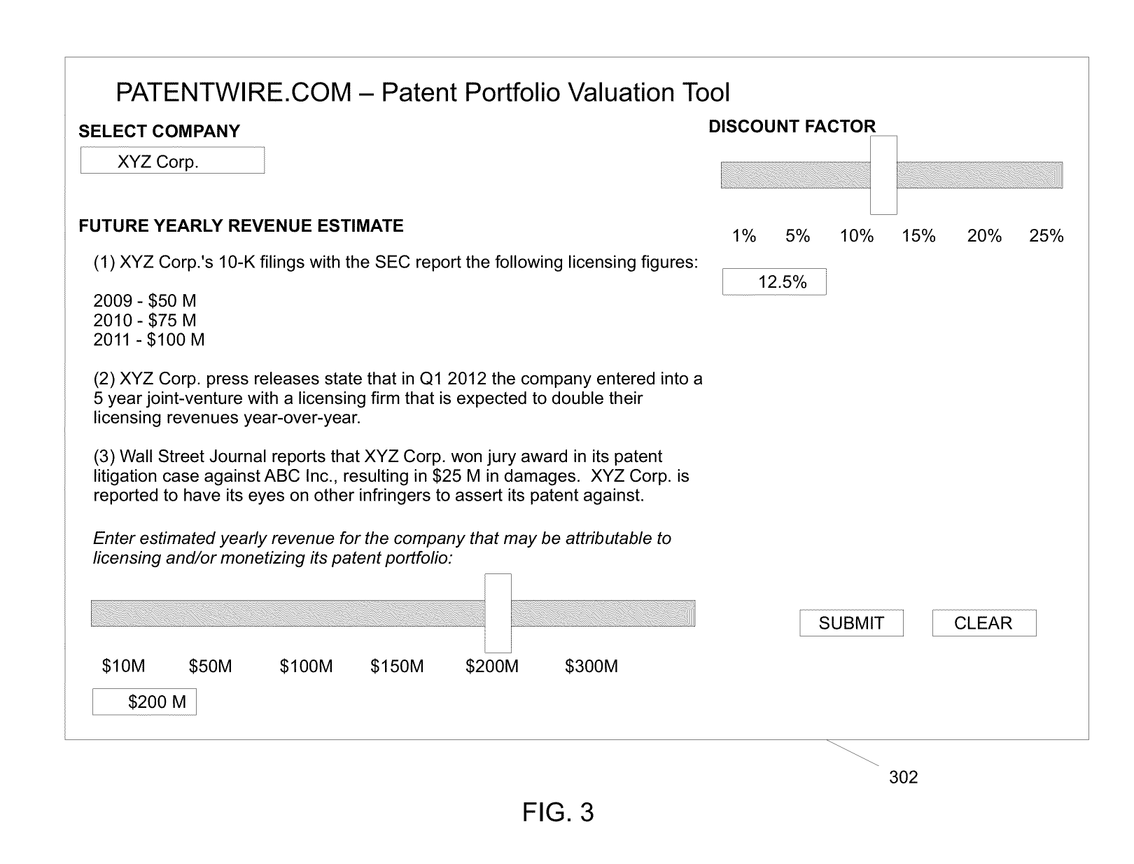

FIG. 3 is a screen layout of the valuation interface in an embodiment of the present invention. The valuation interface 302 allows the user to enter a company name or stock symbol. In an embodiment, the text field can auto-populate, or suggest company names as the user types in a dropdown fashion.

After the user enters a company name, the company name is transmitted to the valuation server, which retrieves financial data matching the company name from the financial database. This financial data displayed on the valuation interface. The financial data is specific to historical licensing and damage award revenues for the company tied directly to its patent portfolio. As shown in FIG. 3, historical licensing revenue from SEC 10-K filings are displayed, as well as press releases from the company's website. In addition, reputable news articles that report on the company's patent-related revenue, such as from the Wall Street Journal, are displayed.

This information is provided to the user so that an informed estimate of future revenue attributable to the company's patent portfolio can be estimated. The user can either manually enter an estimated revenue value, or alternatively, can use a slider bar to select the estimated revenue value, as shown in FIG. 3.

The user can also enter a discount factor in a similar fashion, either manually, or via a slider bar, as shown in FIG. 3.

In another embodiment, the selection tool for either the revenue estimate or the discount factor can be any type of graphical selection tools, such as, but not limited to, text boxes, radio buttons, check boxes, and/or number picker popup (similar to a calendar popup), and any combinations thereof.

The fields shown in the valuation interface 302 are exemplary, and the present invention can include any combination of fields and sub-fields. In an embodiment, the user can select patent data for a specific country, such as the United States, or multiple countries, or aggregate worldwide patent data.

FIG. 4 is a screen layout of the results interface in an embodiment of the present invention. The results interface 402 displays an interactive screen that shows estimated NPV calculations of the selected company's patent portfolio, as well as fields to allow the user to enter their inputs and see updated calculations in real-time.

In an embodiment, the NPV calculations are displayed in a grid format, allowing the user to conduct a visual sensitivity analysis, as well as modify the estimated revenue value and discount factor. Upon changing either of these inputs, the grid is automatically updated with calculations based on the user's new inputs.

In another embodiment, the results are displayed on the results interface 402 in graphical format, and the user can manipulate and interact with the resulting data. For example, various charts, graphs, and maps can be displayed that incorporate patent and financial data related to the resulting company data. The results can be exported to various formats (PDF, image files, etc.), as well as shared via email, Twitter, and/or social media posting.

In an embodiment, depending on a user's subscription level, various querying, viewing, manipulation/interaction, and exporting features can be selectively enabled and/or disabled. Furthermore, such features can be accessed on a pay-per-use basis.

While the principles of the disclosure have been illustrated in relation to the exemplary embodiments shown herein, the principles of the disclosure are not limited thereto and include any modification, variation or permutation thereof.

1. A method for valuing a patent portfolio, comprising:
receiving a company name, multiple revenue estimates, and multiple discount factors at a valuation server from a user interface;
determining, by the valuation server, an average remaining term for a patent portfolio associated with the company;
calculating, by the valuation server, multiple base values of the patent portfolio by multiplying each of the revenue estimates by the average remaining term;
subtracting, by the valuation server, each of the discount factors from the multiple base values to obtain multiple net present values of the patent portfolio; and
displaying the multiple net present values simultaneously on the user interface in a grid format.

2. The method of claim 1, wherein the valuation server retrieves patent records associated with the company from a patent database in order to determine the average remaining term.

3. The method of claim 1, wherein the average remaining term is stored on the valuation server.

4. The method of claim 1, wherein the average remaining term is retrieved by the valuation server from another database.

5. The method of claim 1, further comprising calculating, by the valuation server, a second net present value using an adjusted discount factor, the adjusted discount factor different from each of the multiple discount factors.

6. The method of claim 1, further comprising calculating, by the valuation server, a second net present value using an adjusted revenue estimate, the adjusted revenue estimate different from each of the multiple revenue estimates.

7. The method of claim 5, wherein the net present value and the second net present value are simultaneously displayed on the interface.

8. The method of claim 7, wherein the net present value and the second net present value are simultaneously displayed on the interface.

9. A system for interactively valuing a patent portfolio, comprising:
an interface;
a company name input field on the interface, wherein the company name input field automatically suggests company names as text is entered into the company name input field;
a revenue estimate input on the interface;
a discount factor input on the interface; and
a valuation server communicatively coupled to the interface, the valuation server configured to calculate a net present value of a patent portfolio associated with a company name using a revenue estimate and a discount factor that are input via the interface,
wherein at least one of the revenue estimate input and the discount factor input is a slider scale,
wherein the interface is configured to display the net present value, and wherein the interface is further configured to automatically display an updated net present value if the slider scale is adjusted.

10. The system of claim 9, wherein the interface is further configured to display financial data retrieved from a financial database communicatively coupled to the interface.

11. The system of claim 10, wherein the financial data is selected from a group consisting of historical revenue data, government tax filings, litigation data, press releases, and media articles.

12. The system of claim 9, where the revenue estimate input is a graphical selection tool.

13. The system of claim 9, wherein the discount factor input is a graphical selection tool.

14. The system of claim 9, wherein the revenue estimate input or the discount factor input is interactive.

15. A method for displaying a patent portfolio valuation, comprising:
receiving, by a valuation server, a company name, a revenue estimate, and a discount factor from an interface;
calculating, by the valuation server, a net present value of a patent portfolio associated with the company name using the revenue estimate and the discount factor;
calculating, by the valuation server, multiple net present values of the patent portfolio using adjusted values for at least one of the revenue estimate and the discount factor, wherein the adjusted values include at least one value lower than the revenue estimate or the discount factor, and wherein the adjusted values include at least one value higher than the revenue estimate or the discount factor; and
displaying, on the interface, the net present value and the multiple net present values simultaneously in a grid format.

16. The method of claim 15, wherein the adjusted values are determined by a pre-set value.

17. The method of claim 15, wherein the adjusted values are determined by a user-defined value.

18. The method of claim 15, further comprising receiving, by the valuation server, an updated revenue estimate or an updated discount factor from the interface, after the net present value and the multiple net present values have been displayed on the interface.

19. The method of claim 18, further comprising calculating, by the valuation server, an updated net present value based on the updated revenue estimate or the updated discount factor.

20. The method of claim 19, further comprising displaying the updated net present value on the interface in a grid format along with the net present value and the multiple net present values.
